(19) United States
(12) Patent Application Publication
(10) Pub. No.: US 2005/0095353 A1
(43) Pub. Date: May 5, 2005

(54) Method of curing powder coatings

(76) Inventors: Franziska Isele, Erding (DE); Oliver Reis, Landshut (DE)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/955,222

(22) Filed: Sep. 30, 2004

Related U.S. Application Data
(60) Provisional application No. 60/516,567, filed on Oct. 31, 2003.

(51) Int. Cl. B05D 1/12; B05D 1/00

(52) U.S. Cl. 427/8; 427/180; 427/551

(57) ABSTRACT

A method of curing powder coatings comprising the steps 1. application of the powder coating onto the substrate surface, 2. curing of the coating by means of NIR radiation in a wavelength range of 760 to 1500 nm, wherein the course of the curing is tracked by recording the thermal radiation given off by the coated substrate during curing.

### CROSS-REFERENCE TO RELATED APPLICATION

This application claims the benefit of U.S. Provisional Application Ser. No. 60/516,567 filed on Oct. 31, 2003, which is hereby incorporated by reference in its entirety.

### BACKGROUND OF THE INVENTION

The invention relates to a method of curing powder coatings, whereby the course of the curing process is improved.

Powder coatings, after being applied, may be dried and cured using radiation from the near-infrared range (NIR). During powder coating, NIR technology allows powder coatings to be fused on and cured in a single processing step, see for example K. Bär, JOT 2/98, pp. 26-29 as well as WO 99/41323. Uniform heating and curing of the entire coat may be achieved.

Special radiators are used for NIR irradiation. Such radiators are, in particular, high-intensity halogen lamps which may, for example, reach radiance temperatures of 3500 K. The curing quality and hence, the coating quality cannot always be satisfactorily and reproducibly guaranteed, particularly if, for example, NIR radiators do not achieve the appropriate intensity and/or have shortcomings in their functional performance. This may have a substantial effect upon the degree of curing of the coating and the coating properties.

### SUMMARY OF THE INVENTION

This invention is directed to a method of curing powder coatings after application onto a substrate surface, whereby the course of the curing of the surfaces coated with the powder coating may be efficiently and reproducibly recorded and controlled, thereby enabling the quality of the coating to be improved in terms of flow, lustre and hardness.

The method according to the invention relates to a method in which the powder coating is applied onto the substrate surface and then cured by NIR radiation in a wavelength range of 760 to 1500 nm, wherein the course of the curing of the coating applied to the substrate surface is tracked by recording the thermal radiation given off by the coated substrate during curing.

### DETAILED DESCRIPTION OF THE INVENTION

In accordance with the method according to the invention the powder coating is applied by conventional methods onto the substrate to be coated and is then fused on and cured by means of NIR radiation. The fusing-on and curing generally takes less than 300 seconds, depending on the respective composition of the powder coating.

At the same time, during the curing phase the thermal radiation given off by the coated substrate is recorded, with the result that qualitative and quantitative statements about the curing are possible. The thermal radiation given off may also be recorded after curing of the coated substrate has been effected.

In accordance with the method according to the invention the thermal radiation given off by the coated substrate is scanned by means of a special infrared optical system and converted into electrical signals. These electrical signals are composed into an image, wherein the individual pixels represent different shades of colour as a function of the detected thermal radiation.

From these shades of colour, differences in the curing quality may be detected, i.e., incomplete curing of the coating or of parts of the coating. Evaluation of these shades of colour may be effected by means of EDP (Electronic Data Processing), for example, by way of reference isotherms, which enable a qualitative and a quantitative statement about the state of curing.

In accordance with the method according to the invention the curing phase is preferably linked directly to measurement of the thermal radiation. To this end, in addition to the radiators for the NIR curing, the equipment for measuring the thermal radiation, i.e., the special infrared optical system, is positioned in the powder coating installation.

In this case, the infrared optical system may be positioned directly in the zone of the NIR radiators.

The infrared optical system may also be positioned immediately adjoining the NIR curing zone in the powder coating installation. In this manner, simultaneous and/or successive tracking of the course of the curing process is possible.

After measurement of the thermal radiation, renewed curing of the coating may be effected if the required quality of curing has not been achieved.

This may be effected for example by an additional arrangement of NIR radiators adjoining the device for measuring the thermal radiation, for example, in the after-heating zone of the powder coating installation.

It is also possible, immediately after measurement of the thermal radiation, to use individual NIR radiators in the curing zone of the powder coating installation for renewed curing of the coating or of parts of the coating. For this purpose, for example, the requisite NIR radiators may be selected and kept in operation longer than the remaining NIR radiators.

The method according to the invention is not subject to any restriction regarding the nature of the coatings and/or the coating layers and the substrates to be coated.

What is surprising is that recordal of the thermal radiation of the coated substrate is not influenced by the radiation emitted by the NIR radiators. It might have been expected that at least fractions of the NIR radiation would be simultaneously recorded by the infrared optical system and therefore, have an adverse effect upon the measurement results. The method according to the invention enables independent recordal of the thermal radiation of the coated substrates simultaneously with curing of the coating by means of NIR radiation.

In particular, the method according to the invention is suitable for curing coatings on substrates, which because of their shape are coated and cured in a rotating manner and of which, for example, the heat is impossible to measure by other methods, such as by temperature measurement by means of probes. For rotating substrates, in particular, the method according to the invention enables continuous measurement of the thermal radiation.

The method according to the invention is moreover also particularly suitable for high-speed coating methods, in which the substrate is moved at high speed in one direction while the powder coating is applied onto the substrate and then cured, for example, the coil coating method at belt speeds of for example >50 metres per minute.

The substrates to be measured may have one or more coats which are produced using pigmented and/or non-pigmented paints. Examples are clear lacquers, colouring and/or special-effect basecoats, top coats and fillers. Powder coatings in particular are used to produce the coating layers. The powder coatings may be one- or multi-component coatings, which substantially chemically cross-link.

As powder coatings, it is possible to use the known conventional powder coatings, which may be cured with the aid of NIR radiation. Such powder coatings are described, for example, in WO 99/41323. Given the use of such powder coatings, the powder coating layer is preferably cured immediately after application by exposure to NIR radiation. In this case, the powder fuses and hardens within a very short time.

For example, it is possible to use powder coating compositions based on polyester resins, epoxy resins, (meth)acrylic resins and optionally cross-linking agent resins. The resins may, for example, contain OH, COOH, RNH, NH2 and/or SH as reactive functional groups.

Suitable cross-linking agent resins are, for example, bi- and/or polyfunctional carboxylic acids, dicyandiamide, phenolic resins and/or amino plastics. The functional groups may in this case be bound to the binder to be cross-linked and/or to the cross-linking agent resin (curing agent). The compounds may, for example, contain 15 to 95% by weight of the functionalized resins, such as, for example, polyesters, epoxy resins and/or (meth)acrylic resins, as well as 0.1 to 50% by weight of the functionalized curing agents.

As further components, the powder coatings may contain conventional constituents of powder coating technology, such as pigments and/or fillers as well as coating additives.

Powder coatings based on hydroxy- and/or carboxy-functionalized polyester resins, usable with conventional cross-linking agents, such as for 1.0 example cycloaliphatic, aliphatic or aromatic polyisocyanates, epoxy-group-containing cross-linking agents such as triglycidyl, isocyanurate, polyglycidyl ether based on diethylene glycol, glycicyl-functionalised (meth)acrylic copolymers as well as amino-amido- or hydroxyl-group-containing cross-linking agents may preferably be used.

(Meth)acrylic resins as well as modified vinyl copolymers, for example, based on glycidyl-group-containing monomers and ethylenically unsaturated monomers or graft copolymersare also usable. The (meth)acrylic resins are curable for example by solid dicarboxylic acids as well as carboxy-functional polymers.

Suitable cross-linking agents are moreover: hydroxyl-, carboxyl-, amide- or amine-group-containing curing agents, for example, amino resins such as dicyandiamide and its derivatives, phenolic resins, for example, based on phenol-formaldehyde, which are usable as cross-linking agents for epoxy resins. Bi- and/or polyfunctional carboxylic acids and their derivatives, which are suitable, for example, as cross-linking agents for epoxy-functional acrylic resins, are moreover also usable.

The usable cross-linking agents are contained, for example, in conventional quantities, for example, from 0.1 to 50% by weight in relation to the powder coating composition. Epoxy/polyester hybrid systems are also usable, for example, in an epoxy-to-polyester ratio of 50:50 or 30:70.

Examples of conventional coating additives are degassing agents, flow control agents, flatting agents, texturing agents, light stabilisers. Suitable pigments and fillers are known to the person skilled in the art. The quantities are in the range familiar to the person skilled in the art. For example, the compositions may contain 0 to 50% by weight of pigments and/or fillers. The quantity of the additives is, for example, around 0.01 to 10% by weight.

Manufacture of the powder coatings may be effected using the known extrusion/grinding method or, for example, by atomizing from supercritical solutions or by non-aqueous dispersion methods.

Application of the powder coatings onto the substrate to be coated is effected using known electrostatic spraying techniques, for example, by corona or tribo-sprayguns or using other suitable powder application techniques, in common layer thickness for powder coating. It is also possible to apply the powder in the form of an aqueous dispersion as powder slurry onto the substrate.

The method according to the invention may also be used to cure liquid coatings, for example, refinishing coatings. Conventional liquid coating compositions known to the person skilled in the art may be used for this purpose.

Curing of the applied powder coating is effected by NIR radiation, which generally has a frequency range of 750 to 1500 nm, wherein the powder fuses on and then hardens within a very short time. This operation may take a period of 2 to 300 seconds. As an NIR source, use is made in particular of high-intensity halogen lamps with a radiance temperature of, for example, 3500 K.

The intensity of the NIR radiation may lie, for example, in a range of more than 1 W/cm2 based on the irradiated surface area, preferably more than 10 W/cm2.

The NIR irradiation may also be used in combination with conventional heat sources such as infrared radiation or convection ovens as well as, optionally, with additional reflector systems or lens systems for intensifying the radiation.

Suitable substrates are, in particular, metal, wood, glass, plastics material, paper and foils. The method according to the invention may also be used, for example, for the coil coating method.

The method according to the invention enables efficient and complete curing of powder coatings to the required quality. A particularly notable aspect of the method is that despite the additional measurement of the thermal radiation during the curing process no substantial lengthening of the curing process is caused by the use of the special infrared optical system. With the aid of the method according to the invention, a convenient and efficient means for checking the curing process inside a powder coating installation is achieved.

The present invention further relates to an arrangement for curing powder coatings inside a powder coating installation, which arrangement is such that an infrared optical system is provided in the curing zone of the powder coating installation in addition to the NIR radiators or downstream of the curing zone, and such that optionally further NIR radiators are disposed adjoining the infrared optical system.

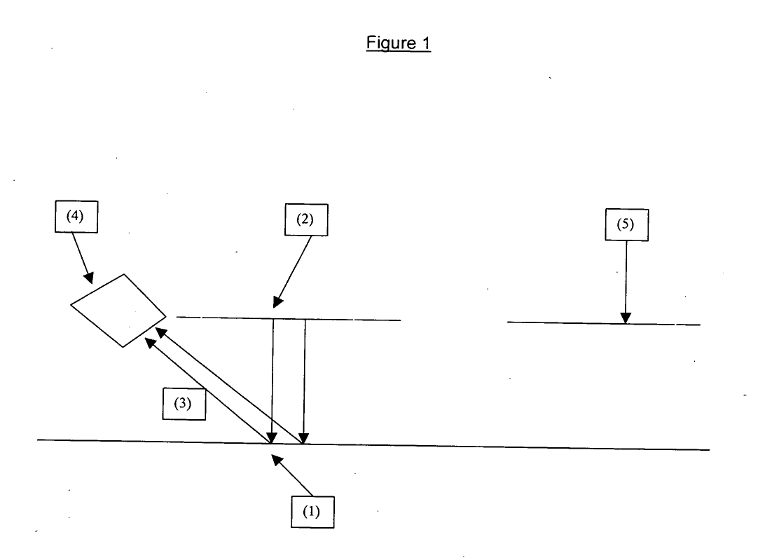

The accompanying FIG. 1 shows a schematic sketch of the arrangement according to the invention in an exemplary construction.

The powder coating (1) to be cured on the substrate surface is irradiated by means of the NIR radiators (2). During this time, the thermal radiation (3) given off by the coated substrate (1) is recorded in the form of a data file or an image by means of an infrared optical system (4). Adjoining the actual NIR zone, in the after-heating zone, additional NIR radiators (5) are provided and intended for the eventuality that insufficiently cured regions of the coating require post-curing.

The invention is described with reference to the following example: The terms in g (gram) result in a 100 g powder coating composition.

### EXAMPLE

A warmed up and rotating bottle of glass is coated with a polyester-epoxy-hybrid powder coat. This coat contains 54.45 g polyester resin Uralac P 3270 (DSM), 23.36 g epoxy resin Epikote® 3003 (Shell Chemie), 19.40 g barium sulphate Mikro Baryt BB-5 (Scheruhn Ind.) as filler, 1.19 g flow promoting agent Resiflow PV5 (Worlee-Chemie), 0.6 g degassing agent Benzoin® and 1 g black pigment Printex 300 (Degussa). After coating with tribo spray guns, the coating is cured with the NIR Highburn Emitter of the company Adphos. A black and glossy coating results.

It can be identified by DSC (Differencial Scanning Calorimetry) measurement that the coating has not cured completely in different areas. The DSC measurement destroys the coating surface. Therefore, after-heating of the coating is not possible.

Another common method in the coating industry, the measurement of gloss, does not provide any result that shows how high a temperature (° C.) is necessary to achieve a complete curing of the areas that have been coated.

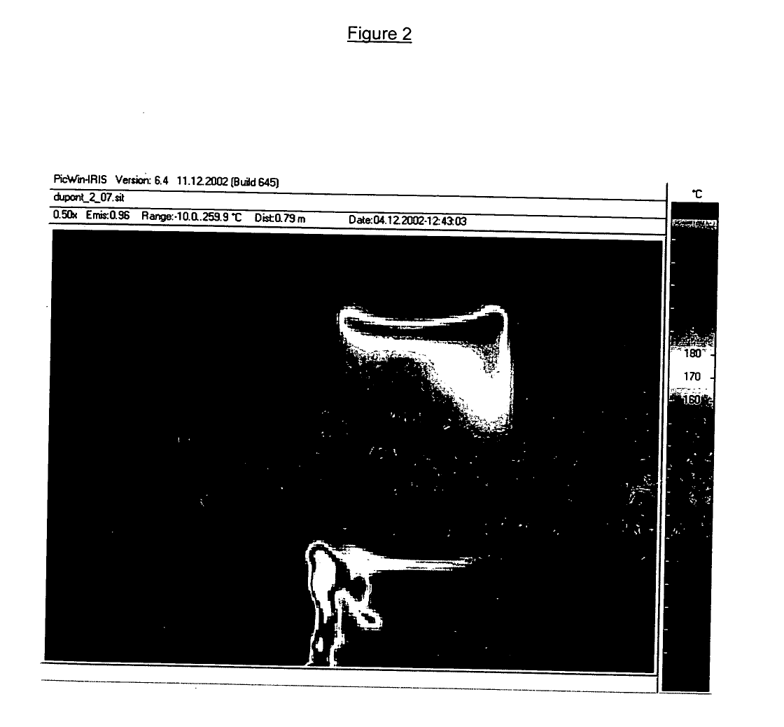

An additional warmed up and rotating bottle of glass is coated with the same polyester-epoxy-hybrid powder coat and is cured under the same conditions, but using a camera to measure the thermal radiation given off by the coated substrate while curing with NIR irradiation. This camera is a NEC San-ei TH7102 MX/WX of the company NEC. The results are shown by a heating picture per computer technology, see FIG. 2.

Several areas of the coated bottle did not show the temperature which is necessary for a complete curing of the coating. Therefore, these areas are heated again by NIR irradiation to achieve the temperature. A uniform heating and a uniform and complete curing of the coating resulted.

1. A method of curing a powder coating after application to a substrate surface comprising the steps
1. applying the powder coating onto the substrate surface,
2. curing of the coating by means of NIR radiation in a wavelength range of 760 to 1500 nm, wherein the course of the curing of the coating is tracked by recording the thermal radiation given off by the coated substrate during curing.

2. The method according to claim 1 wherein the thermal radiation is measured by an infrared optical system.

3. The method according to claim 2 wherein by means of the infrared optical system, the thermal radiation given off is scanned and converted into electrical signals, these signals are composed into an image and different shades of colour are associated with the individual pixels as a function of the sensed infrared radiation.

4. The method according to claim 2 wherein evaluation of the measurement of the thermal radiation is effected with the aid of EDP-assisted measures.

5 The method according to claim 1 wherein renewed curing is effected by additional NIR radiators in the after-heating zone of the powder coating installation.

6. The method according to claim 1 wherein renewed curing is effected using the NIR radiators situated in the curing zone of the powder coating installation.

7. The method according to claim 1 wherein the powder coating for the NIR curing, comprises conventional powder coatings based on one or more polyester resins, epoxy resins and/or (meth)acrylic resins and optionally, cross-linking agent resins are used.

8. The method according to claim 7 wherein powder coatings based on hydroxy- and/or carboxy-functionalized polyester resins, (meth)acrylic resins and/or polyester/epoxy hybrid systems is used.

9. The method according to claim 1 wherein NIR radiation with an intensity of more than 1 Watt per square centimetre is used for the curing.

10. The method according to claim 1 wherein the substrate is coated and cured in a rotating manner.

11. The method according to claim 1 wherein the substrate is coated and cured using the coil coating method.

12. An apparatus for the curing of a powder coating in accordance with the method of claim 1 wherein an infrared optical system is positioned in the curing zone of the powder coating installation in addition to the NIR radiators or downstream of the curing zone.

13. The apparatus according to claim 12 wherein further NIR radiators are disposed adjoining the infrared optical system.
